(19) United States
(12) Patent Application Publication
(10) Pub. No.: US 2006/0126447 A1
(43) Pub. Date: Jun. 15, 2006

(54) Remote control system for an optical disc player and related method

(75) Inventors: Bradley Thomas Collar, Valencia, CA (US); Zeev Bar-Am, Studio City, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Warner Bros. Entertainment Inc.

(21) Appl. No.: 11/250,148

(22) Filed: Oct. 12, 2005

Related U.S. Application Data
(60) Provisional application No. 60/617,851, filed on Oct. 12, 2004.

(51) Int. Cl. H04B 1/20

(52) U.S. Cl. 369/5

(57) ABSTRACT

An apparatus that is configured to receive a first signal from a remote device, to convert the first signal into a second signal, and to transmit the second signal to an optical disc player. The apparatus includes a receiver, a micro processing unit, and a transmitter. The receiver is configured to receive the first signal that is output from the remote device. The micro processing unit is coupled to the receiver, and is configured to convert the first signal into the second signal that is compatible with the optical disc player. The transmitter is coupled to the micro processing unit, and is configured to transmit the second signal to the optical disc player.

### CROSS-REFERENCE TO RELATED APPLICATION

Priority is claimed under 35 U.S.C. § 119(e) to U.S. Provisional Patent Application No. 60/617,851, filed on Oct. 12, 2004, entitled “Remote Control System for DVD Player and Related Method,” by Bradley Thomas Collar and Zeev Bar-Am, which application is incorporated by reference herein.

### BACKGROUND OF THE INVENTION

1. Field of the Invention

The invention relates generally to the field of remote control systems for optical disc players. More specifically, the invention relates to a remote control system for multiple optical disc players.

2. Description of the Related Art

Typically, a single remote control is used to operate a single optical disc player. During the quality control review of multiple optical discs, it is difficult to simultaneously operate more than one optical disc player at a time, because optical disc player remote controls that can be used to operate more than one optical disc player at a time are not known to be commercially available. Accordingly, there is a need for remote control system that provides a user with the ability to simultaneously and remotely control more than one optical disc player. The preset invention satisfies this need.

### SUMMARY OF THE INVENTION

Embodiments of the present invention include an apparatus and method that provide a user with the ability to remotely control more than one optical disc player. An exemplary embodiment of the present invention is an apparatus that is configured to receive a first signal from a remote device, to convert the first signal into a second signal, and to transmit the second signal to an optical disc player. The apparatus includes a receiver, a micro processing unit, and a transmitter. The receiver is configured to receive the first signal, which is output from the remote device. The micro processing unit is coupled to the receiver, and is configured to convert the first signal into the second signal, which is compatible with the optical disc player. The transmitter is coupled to the micro processing unit, and is configured to transmit the second signal to the optical disc player.

In other, more detailed features of the invention, the receiver is configured to receive an infra-red signal, and the first signal is an infra-red signal. Also, the transmitter is configured to transmit an infra-red signal, and the second signal is an infra-red signal. In addition, the apparatus can further include a power unit, which is coupled to the receiver, the micro processing unit, and the transmitter. The power unit is configured to provide electrical power to the receiver, the micro processing unit, and the transmitter.

In other, more detailed features of the invention, the micro processing unit includes a first micro processing unit and a second micro processing unit. The first micro processing unit is coupled to the receiver, and is configured to interpret the first signal that is received by the receiver. The second micro processing unit is coupled between the first micro processing unit and the transmitter. The second micro processing unit is configured to communicate with the first micro processing unit. The second micro processing unit is configured to prompt the transmitter to transmit the second signal.

Another exemplary embodiment of the invention is an apparatus that is configured to be coupled to an optical disc player. The apparatus includes a remote device, which is configured to transmit a first signal, a remote control expansion box, which is coupled to the optical disc player, and a computer, which is coupled to the remote control expansion box. The remote control expansion box includes a receiver, a micro processing unit, which is coupled to the receiver, and a transmitter, which is coupled to the micro processing unit. The receiver is configured to receive the first signal that is output from the remote device. The micro processing unit is configured to convert the first signal into a second signal. The transmitter is configured to transmit the second signal to the optical disc player. The computer includes software that is used to control the operation of the remote control expansion box.

In other, more detailed features of the invention, the micro processing unit is configured to receive a third signal from the computer. The micro processing unit is configured to convert the third signal into a fourth signal. The transmitter is configured to transmit the fourth signal to the optical disc player, thus, allowing the computer to communicate with the optical disc player via the remote control expansion box.

In other, more detailed features of the invention, the remote control expansion box further includes an output terminal, which is coupled to the transmitter, and the apparatus further -includes a repeater and an extension cable. The repeater is coupled to the optical disc player, and the extension cable is coupled between the repeater and the output terminal.

In other, more detailed features of the invention, the apparatus further includes a server, an emulator, and a monitor. The server is coupled to the computer, and is configured to store data. The emulator is coupled to the server, and is configured to read the data from the server. The emulator also is configured to simulate the function of the optical disc player based on the data read from the server. The monitor is coupled to the emulator, and is configured to display the data read from the server as if the monitor was displaying a signal output from the optical disc player.

An exemplary method according to the invention is a method for remotely controlling two or more optical disc players. The method includes providing a system remote control, providing a remote control expansion box, which is coupled to each of the two or more optical disc players, selecting a button on the system remote control, and using the system remote control to generate and to transmit a first signal from the remote control to the remote control expansion box that corresponds to the button that was selected on the system remote control. Also, the method includes using the remote control expansion box to perform the following steps: receiving the first signal that was transmitted by the system remote control, converting the first signal into a second signal and a third signal, wherein the second signal is compatible with one of the two or more optical disc players, and the third signal is compatible with another of the two or more optical disc players, transmitting the second signal to the one of the two or more optical disc players, and transmitting the third signal to the another of the two or more optical disc players.

In other, more detailed features of the invention, the second signal and the third signal simultaneously are transmitted from the remote control expansion box to the two or more optical disc players. Also, the method can further include providing a computer, which is coupled to the remote control expansion box. The computer is configured to save navigation commands into a navigation template file, which is stored in the computer. The navigation commands include information related to the button selected on the system remote control, and a sequence in which the button, along with other buttons, are selected on the system remote control. The navigation template file is configured to be used to control the operation of the remote control expansion box without the use of the system remote control.

In other, more detailed features of the invention, the method further includes providing a computer, which is coupled to the remote control expansion box, and within which is stored a remote command table for each type of optical disc player that is coupled to the remote control expansion box; using the computer to access the remote command table, which is stored within the computer, and to transmit the remote command table to the remote control expansion box; and using the remote command table in the remote control expansion box during the conversion of the first signal into either the second signal or the third signal. Also, the computer can be configured to receive the remote command table from a recordable medium or another computer via the Internet.

In other, more detailed features of the invention, the computer, in combination with the remote control expansion box, is configured to control the operation of the more than one optical disc player without the use of the remote control. Also, the computer can include a monitor that is configured to display a graphical user interface, and the method can further include using the graphical user interface to control the operation of the more than one optical disc players. In addition, the method can further include using the graphical user interface to store in the computer a report, which includes information selected from the group consisting of project information, a project name, an operator name, a date, a region code, and a comment.

In other, more detailed features of the invention, the computer is configured to generate the remote command table for a type of optical disc player by performing the following steps for the type of optical disc player: providing a player remote control that is configured to communicate directly with the type of optical disc player, selecting a button on the player remote control, using the player remote control to generate and to transmit a fourth signal from the player remote control to the remote control expansion box that corresponds to the button that was selected on the player remote control, using the remote control expansion box to receive the fourth signal that corresponds to the button that was selected on the player remote control, using the computer to store a fifth signal that was generated by the remote control expansion box upon receipt of the fourth signal, and that corresponds to the button selected on the player remote control, using the computer to generate a portion of the remote command table by associating the fifth signal with the functionality of the button selected on the player remote control, and repeating the above steps for other buttons included on the player remote control. Also, the computer can be configured to generate a remote command table for each type of optical disc player that is coupled to the remote control expansion box by repeating the above steps for each of the types of optical disc players that is coupled to the remote control expansion box.

Other features of the invention should become apparent from the following description of the preferred embodiments taken in conjunction with the accompanying drawings, which illustrate, by way of example, the principles of the invention.

### DESCRIPTION OF THE DRAWINGS

FIG. 1 is a block diagram of an optical disc quality control system according to a preferred embodiment.

FIG. 2 is a block diagram of a remote control expansion box that is included in the optical disc quality control system of FIG. 1.

FIG. 3 is a block diagram of an optical disc quality control system, which includes an optical disc emulator according to a preferred embodiment.

### DETAILED DESCRIPTION OF THE PREFERRED EMBODIMENTS

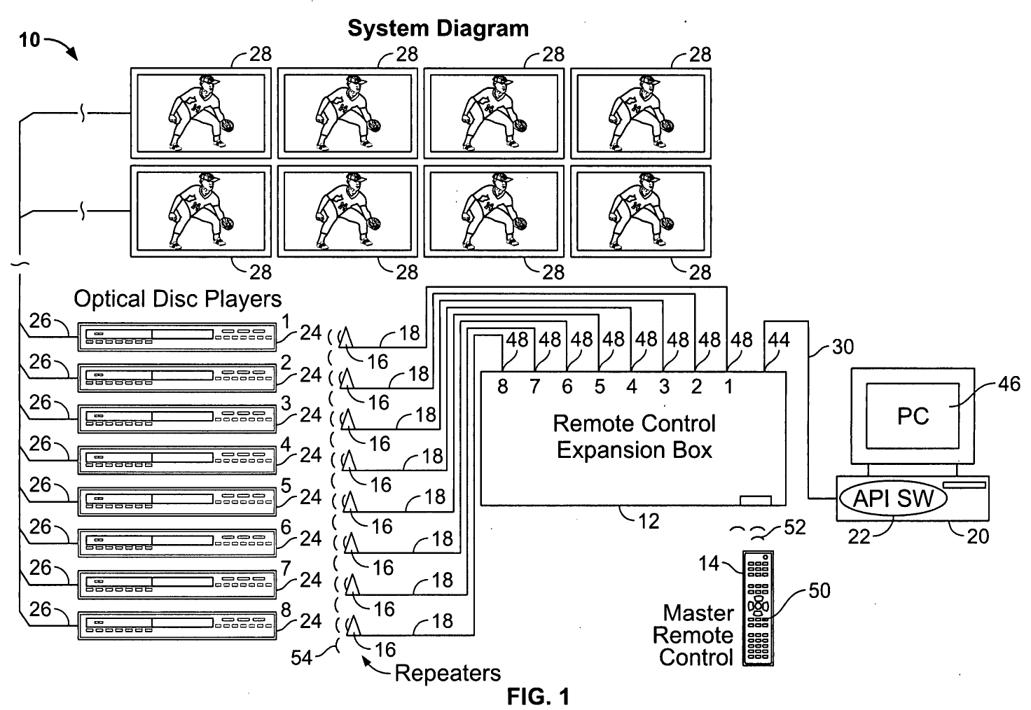

Referring to the block diagram of FIG. 1, embodiments of the present invention provide for an optical disc, e.g., a digital video disc (“DVD”), quality control (“QC”) system 10 that includes a remote control expansion box (“RCEB”) 12, a master remote control unit 14 (also referred to as a remote device or a system remote control), repeaters 16, e.g., infra-red (“IR”) repeaters, with associated extension cables 18, a computer (“PC”) 20 with associated application software (“API SW”) 22, various optical disc players 24, e.g., DVD players, with associated audio/video cables 26, and monitors 28 (or single monitor which can display multiple video inputs). The RCEB is coupled to the repeaters via the associated extension cables. The RCEB also is coupled to the PC via a standard computer cable 30, e.g., RS232. The monitors (or single monitor which can display multiple video inputs) are coupled to the optical disc players via standard audio/video cables. Each repeater is fastened firmly to the input window (not shown), e.g., an IR window, of each optical disc player respectively.

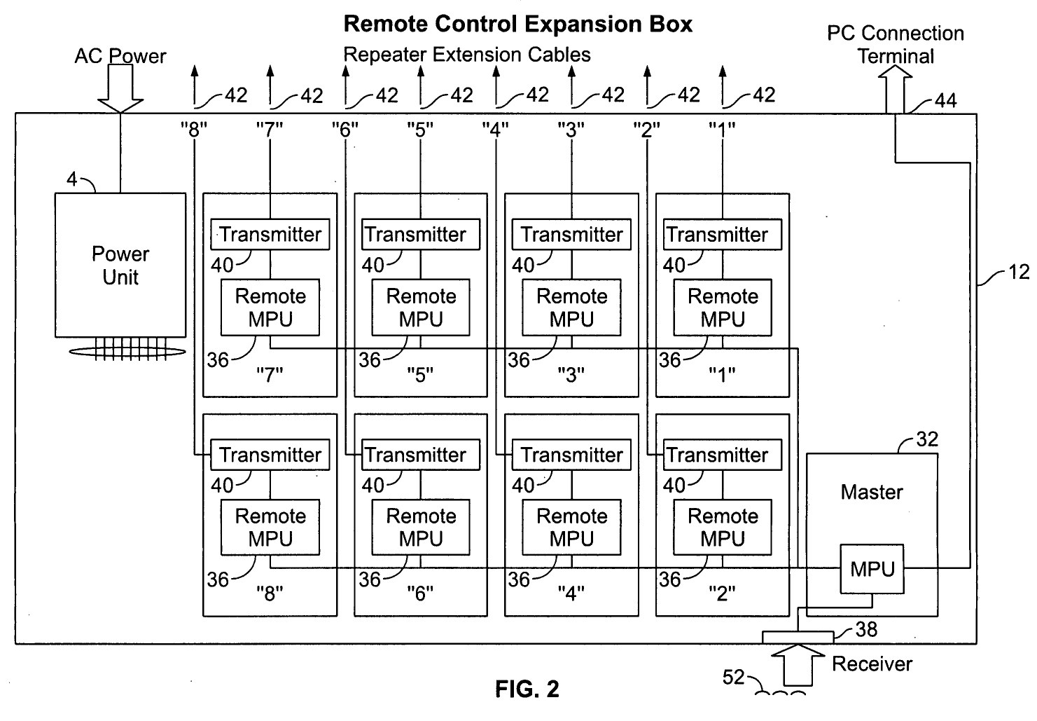

Referring additionally to the block diagram of FIG. 2, the RCEB 12 includes a master micro processing unit (“master MPU”) 32 (also referred to as a first micro processing unit), a power unit 34, several remote micro processing units (“remote MPUs”) 36 (also individually referred to as a second micro processing unit), a receiver 38, e.g., an IR receiver, several transmitters 40, e.g., IR transmitters, and corresponding output terminals 42, and a PC connection terminal 44. The receiver and PC connection terminal are coupled to the master MPU. In addition, the master MPU is coupled to each of the remote MPUs. Each remote MPU is coupled to a corresponding transmitter. Each transmitter is coupled to its associated output terminal. The power unit is used to provide power to the various components of the RCEB.

Before the optical disc QC system 10 can be used, the system must undergo a remote control learning process, whereby the remote control commands for the various brands/models of optical disc players 24 to be integrated into the system are recorded and stored into the system memory (not shown). A user first launches the API SW 22 located on the PC 20, and then, switches the software into “Record Mode” (not shown). The user then presses the key or button (not shown) on the virtual remote control of the API SW's graphical user interface (“GUI”) (not shown), which is displayed on the PC's monitor 46 and corresponds to one of the optical disc navigation commands, e.g., play (not shown). Next, using the actual remote control (not shown) (also referred to as the player remote control) for the optical disc player to be integrated into the system, the user presses the key or button on the remote control corresponding to the same optical disc navigation command, e.g., play.

A signal, e.g., an IR signal, is sent from the remote control (not shown) and captured by the receiver 38 of the RCEB 12, and then transferred to the master MPU 32. The master MPU interprets the remote control command and transfers the information to the API SW 22 located on the PC 20 where it is stored into a remote command table in memory (not shown).

This remote learning process is repeated for every command of the remote control (not shown). After all commands have been transferred into the system 10, the user can save the remote command table using the API SW's GUI (not shown) under a designated optical disc player brand/model. The same process is repeated for the other optical types of disc players 24 and their corresponding remote controls (not shown).

The commands learned are limited to the DVD Video user operation functions as defined in DVD Specifications For Read-Only Disc, Part 3 Video Specifications, Annex J. However, this does not preclude the system 10 from being used with other optical disc player systems, e.g., HD-DVD, Blu-ray, EVD, VCD, and X-Box.

In some cases remote control command codes are available for download from websites (not shown), or directly available from certain manufacturers. Therefore, it may be possible to forgo the manual remote control learning process described above. Instead, a user would retrieve and store the various remote command tables directly from a website, via the Internet, or physical media (not shown).

After the API SW 22 has stored the various remote command tables, the optical disc QC system 10 is ready for use. Using the API SW's GUI (not shown), the user selects the various brands/models of optical disc players 24 to be controlled by the system. The user also selects the output terminal 42 number for each brand/model to be controlled. For each optical disc player brand/model selected, the API SW sends the remote command table for that particular optical disc player brand/model and output terminal number to the master MPU 32 of the RCEB 12. The master MPU forwards each remote command table to the remote MPU 36 corresponding to the output terminal number selected by the user. The remote MPU stores the remote command table that it receives into memory (not shown).

For illustration purposes, the RCEB 12 shown in FIGS. 1 and 2 has eight output terminals, or outputs, 48, however, the number of outputs can be increased by increasing the number of remote MPUs 36 and transmitters 40 in the RCEB. In addition, multiple RCEBs can be clustered together (not shown), allowing for more optical disc players 24 to be controlled simultaneously.

The API SW 22 allows the user to group a particular set of optical disc player brands/models 24 with corresponding output terminal 42 and 48 numbers, and to store the group under a designated group name. For example, a group can be created which contains all of the NTSC Region 1 DVD player brands/models, another group can be created which contains all of the PAL Region 2 DVD player brands/models, and so on.

After the optical disc players 24 to be controlled have been selected as described above, and optical discs (not shown) have been loaded into each corresponding optical disc player, the user can control all of the optical disc players at the same time with the master remote control 14 shown in FIG. 1 (this mode of operation is called “the manual QC mode”). When the user presses a key or button 50 on the master remote control, a signal 52, e.g., an IR signal, is transmitted by the master remote control corresponding to the key pressed, e.g., play. The signal is captured by the RCEB's receiver 38 and transferred to the master MPU 32. The master MPU interprets the remote control command, and then, transfers the information to each of the remote MPUs 36 as well as to the PC 20.

Each remote MPU 36 receives the remote control command information, and, using the remote command table stored in memory (not shown), sends the appropriate signal characteristics for the particular brand/model of optical disc player 24 to the transmitter 40. The transmitter then transmits the appropriate signal to the output terminal 42 and 48 of the RCEB 12 where it travels across the repeater extension cable 18 to the repeater 16. The repeater then transmits the signal 54 to the optical disc player to which it is coupled.

During manual QC mode operation, the API SW 22 stored in the PC 20 receives the remote control command information and stores the navigation command into a navigation template file (not shown). As each subsequent key 50 is pressed on the master remote control 14, each corresponding navigation command is stored into the navigation template file along with the specified time intervals between each command. After the QC process is complete the navigation template file can be named, modified, and saved onto the PC or a server (not shown). An unlimited number of navigation template files can be created and stored for future use.

During manual QC mode operation, the user can use a virtual remote control (not shown) contained in the API SW GUI (not shown), which is displayed on the PC's monitor 46, to control the optical disc players 24 in place of using the master remote control 14. In such a case, when the user presses a key (not shown) on the virtual remote control, the remote control command information is sent directly to the RCEB's master MPU 32 as well as being stored into the navigation template file (not shown).

The stored navigation template file (not shown) that is created during manual QC mode operation can be used in subsequent QC sessions in the program QC mode. The user can switch the system 10 into program QC mode using the API SW GUI (not shown) located on the PC 20, and then, select the navigation template file to be used. The API SW 22 then transmits the navigation template file to the RCEB's master MPU 32. The master MPU then automatically executes each navigation command in the exact sequence, and with the specified time intervals, indicated in the navigation template file. As each navigation command is executed, the master MPU sends the corresponding remote control command information to each corresponding remote MPU 36.

Each remote MPU 36 receives the remote control command information, and, using the remote command table (not shown) stored in memory (not shown), sends the appropriate signal characteristics for the particular brand/model of optical disc player 24 to the transmitter 40. The transmitter then transmits the appropriate signal to the output terminal 42 and 48 of the RCEB 12 where it travels through the repeater extension cable 18 to the repeater 16. The repeater then transmits the signal 54 to the optical disc player to which it is attached.

During program QC mode operation, the user can pause and/or manually step through the execution of the navigation commands using the API SW GUI (not shown).

While in manual QC mode or program QC mode, the user can enter textual comments (not shown) via the API SW GUI (not shown). In addition, ancillary project information can be entered via the API SW GUI, e.g., project name, operator name, date, and region code. All of the user comments and project information can be saved into a QC report (not shown). The QC report also contains all of the navigation commands, time intervals between each command, and the specific optical disc players 24 used for the QC session. The API SW located on the PC 20 allows the user to display and print the QC report.

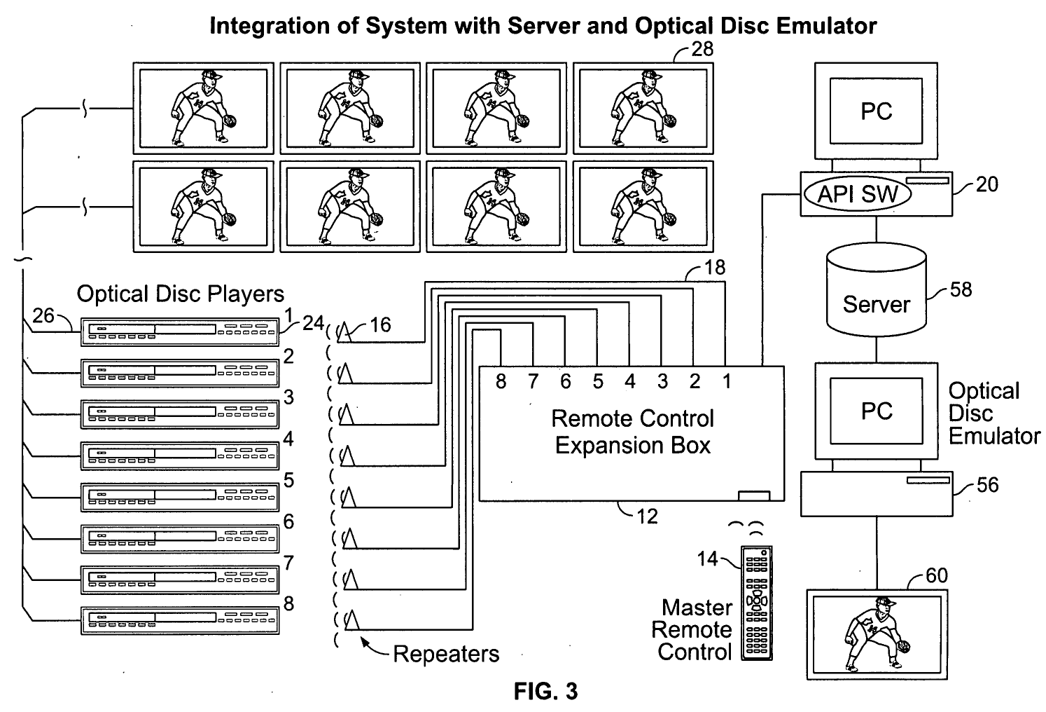

Referring additionally to block diagram of FIG. 3, through the course of the optical disc authoring process, an optical disc emulator 56, e.g., a DVD emulator, (PC-based software/hardware that simulates an optical disc player) can be used to perform quality control checks prior to optical disc manufacturing. An optical disc emulator reads the optical disc data (not shown) from a file server 58, or local hard drive (not shown), and plays the data back, displaying it on a monitor 60, as if it is an actual optical disc playing in an optical disc player. During the emulation QC process, the optical disc emulator software (not shown) can store the navigation commands into a navigation template file (not shown). The navigation template can be stored on the optical disc emulator's local hard drive, or on a server. As indicated in FIG. 3, the optical disc emulator can be connected to the same server as the system 10.

A preferred method of performing optical disc quality control involves first performing emulation QC using an optical disc emulator 56, and storing the generated navigation template file (not shown) on the server 58. After disc manufacturing, the navigation template file is downloaded from the server and used by the system 10 in the program QC mode to check the manufactured discs (not shown) automatically in a wide variety of brands/models of optical disc players 24. During the program QC mode process, the user can pause and/or step through individual navigation commands, and enter comments into the API SW 22 when necessary. After the QC session is complete, the system will generate a QC Report (not shown) that can be displayed the PC's screen 46 and printed.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1. An apparatus that is configured to receive a first signal from a remote device, to convert the first signal into a second signal, and to transmit the second signal to an optical disc player, the apparatus comprising:
a. a receiver that is configured to receive the first signal that is output from the remote device;
b. a micro processing unit that is coupled to the receiver, and that is configured to convert the first signal into the second signal that is compatible with the optical disc player; and
c. a transmitter that is coupled to the micro processing unit, and that is configured to transmit the second signal to the optical disc player.

2. The apparatus according to claim 1, wherein:
a. the receiver is configured to receive an infra-red signal; and
b. the first signal is an infra-red signal.

3. The apparatus according to claim 1, wherein:
a. the transmitter is configured to transmit an infra-red signal; and
b. the second signal is an infra-red signal.

4. The apparatus according to claim 1, wherein:
a. the micro processing unit includes a first micro processing unit and a second micro processing unit;
b. the first micro processing unit is coupled to the receiver, and is configured to interpret the first signal that is received by the receiver; and
c. the second micro processing unit is coupled between the first micro processing unit and the transmitter, the second micro processing unit is configured to communicate with the first micro processing unit, and the second micro processing unit is configured to prompt the transmitter to transmit the second signal.

5. The apparatus according to claim 1, further comprising a power unit that is coupled to the receiver, the micro processing unit, and the transmitter, and the power unit is configured to provide electrical power to the receiver, the micro processing unit, and the transmitter.

6. An apparatus that is configured to be coupled to an optical disc player, the apparatus comprising:
a. a remote device that is configured to transmit a first signal;
b. a remote control expansion box that is coupled to the optical disc player, and that includes:
i. a receiver that is configured to receive the first signal that is output from the remote device,
ii. a micro processing unit that is coupled to the receiver, and that is configured to convert the first signal into a second signal, and
iii. a transmitter that is coupled to the micro processing unit, and that is configured to transmit the second signal to the optical disc player; and
c. a computer that is coupled to the remote control expansion box, and that includes software that is used to control the operation of the remote control expansion box.

7. The apparatus according to claim 6, wherein:
a. the receiver is configured to receive an infra-red signal; and
b. the first signal is an infra-red signal.

8. The apparatus according to claim 6, wherein:
a. the transmitter is configured to transmit an infra-red signal; and
b. the second signal is an infra-red signal.

9. The apparatus according to claim 6, wherein:
a. the micro processing unit includes a first micro processing unit and a second micro processing unit;
b. the first micro processing unit is coupled to the receiver, and is configured to interpret the first signal that is received by the receiver; and
c. the second micro processing unit is coupled between the first micro processing unit and the transmitter, the second micro processing unit is configured to communicate with the first micro processing unit, and the second micro processing unit is configured to prompt the transmitter to generate the second signal.

10. The apparatus according to claim 6, wherein:
a. the remote control expansion box further includes a power unit that is coupled to the receiver, the micro processing unit, and the transmitter; and
b. the power unit is configured to provide electrical power to the receiver, the micro processing unit, and the transmitter.

11. The apparatus according to claim 6, wherein
a. the micro processing unit is configured to receive a third signal from the computer;
b. the micro processing unit is configured to convert the third signal into a fourth signal; and
c. the transmitter is configured to transmit the fourth signal to the optical disc player, thus, allowing the computer to communicate with the optical disc player via the remote control expansion box.

12. The apparatus according to claim 6, wherein the remote control expansion box further includes an output terminal that is coupled to the transmitter, and the apparatus further comprises:
a. a repeater that is coupled to the optical disc player; and
b. an extension cable that is coupled between the repeater and the output terminal.

13. The apparatus according to claim 6, further comprising:
a. a server that is coupled to the computer, and that is configured to store data;
b. an emulator that is coupled to the server, that is configured to read the data from the server, and that is configured to simulate the function of the optical disc player based on the data read from the server; and
c. a monitor that is coupled to the emulator, and that is configured to display the data read from the server as if the monitor was displaying a signal output from the optical disc player.

14. A method for remotely controlling two or more optical disc players, the method comprising:
a. providing a system remote control;
b. providing a remote control expansion box that is coupled to each of the two or more optical disc players;
c. selecting a button on the system remote control;
d. using the system remote control to generate and to transmit a first signal from the remote control to the remote control expansion box that corresponds to the button that was selected on the system remote control; and
e. using the remote control expansion box to perform the following steps:
i. receiving the first signal that was transmitted by the system remote control,
ii. converting the first signal into a second signal and a third signal, wherein the second signal is compatible with one of the two or more optical disc players, and the third signal is compatible with another of the two or more optical disc players,
iii. transmitting the second signal to the one of the two or more optical disc players, and
iv. transmitting the third signal to the another of the two or more optical disc players.

15. The method according to claim 14, wherein the second signal and the third signal simultaneously are transmitted from the remote control expansion box to the two or more optical disc players.

16. The method according to claim 14, further comprising providing a computer that is coupled to the remote control expansion box, and that is configured to save navigation commands into a navigation template file that is stored in the computer, wherein:
a. the navigation commands include information related to the button selected on the system remote control, and a sequence in which the button, along with other buttons, are selected on the system remote control; and
b. the navigation template file is configured to be used to control the operation of the remote control expansion box without the use of the system remote control.

17. The method according to claim 14, further comprising:
a. providing a computer that is coupled to the remote control expansion box, and within which is stored a remote command table for each type of optical disc player that is coupled to the remote control expansion box;
b. using the computer to access the remote command table that is stored within the computer, and to transmit the remote command table to the remote control expansion box; and
c. using the remote command table in the remote control expansion box during the conversion of the first signal into either the second signal or the third signal.

18. The method according to claim 17, wherein the computer is configured to receive the remote command table from a recordable medium or another computer via the Internet.

19. The method according to claim 17, wherein the computer in combination with the remote control expansion box is configured to control the operation of the more than one optical disc player without the use of the remote control.

20. The method according to claim 19, wherein the computer includes a monitor that is configured to display a graphical user interface, and further comprising using the graphical user interface to control the operation of the more than one optical disc players.

21. The method according to claim 20, further comprising using the graphical user interface to store in the computer a report that includes information selected from the group consisting of project information, a project name, an operator name, a date, a region code, and a comment.

22. The method according to claim 17, wherein the computer is configured to generate the remote command table for a type of optical disc player by performing the following steps for the type of optical disc player:
a. providing a player remote control that is configured to communicate directly with the type of optical disc player;
b. selecting a button on the player remote control;
c. using the player remote control to generate and to transmit a fourth signal from the player remote control to the remote control expansion box that corresponds to the button that was selected on the player remote control;
d. using the remote control expansion box to receive the fourth signal that corresponds to the button that was selected on the player remote control;
e. using the computer to store a fifth signal that was generated by the remote control expansion box upon receipt of the fourth signal, and that corresponds to the button selected on the player remote control;
f. using the computer to generate a portion of the remote command table by associating the fifth signal with the functionality of the button selected on the player remote control; and
g. repeating the above steps a. through f. for other buttons included on the player remote control.

23. The method according to claim 22, wherein the computer is configured to generate a remote command table for each type of optical disc player that is coupled to the remote control expansion box by repeating the steps included in claim 22 for each of the types of optical disc players that is coupled to the remote control expansion box.
